(19) United States
(12) Patent Application Publication
(10) Pub. No.: US 2005/0203305 A1
(43) Pub. Date: Sep. 15, 2005

(54) Oil extraction system

(76) Inventor: Michael L. Britt, Christmas, FL (US)

Correspondence Address: Mitchell Rose, Ph.D.;Jones Day, North Point, 901 Lakeside Avenue, Cleveland, OH, 44114, US

(21) Appl. No.: 10/798,767

(22) Filed: Mar. 11, 2004

(51) Int. Cl. C11B 1/00

(52) U.S. Cl. 554/8

(57) ABSTRACT

An oil extraction method comprises pumping a solvent in liquid phase from a solvent reservoir through an oil containing material for the solvent to extract oil from the material to yield a mixture of the solvent and the oil. The mixture is deposited in a distillation tank. The solvent is distilled off the mixture in the tank in the form of a solvent vapor. The solvent vapor is thermally driven from the reservoir back to the tank by applying a temperature differential between the tank and the reservoir, while leaving the oil in the tank.

### TECHNICAL FIELD

This application relates to devices for extracting oils from oil bearing materials.

### BACKGROUND

A volatile solvent can be used to extract oil from an oil bearing material. This is done by passing the solvent through the material. A mixture of the solvent and the oil is collected in a distillation tank. The solvent is distilled off, leaving the oil retained in the tank.

### SUMMARY

An oil extraction method comprises pumping a solvent in liquid phase from a solvent reservoir through an oil containing material for the solvent to extract oil from the material to yield a mixture of the solvent and the oil. The solvent/oil mixture is deposited in a distillation tank. The solvent is distilled off the mixture in the form of a solvent vapor. The solvent vapor is thermally driven from the tank back to the reservoir by applying a temperature differential, while leaving the oil in the tank.

An oil extraction apparatus comprises first and second oil extraction systems. Each system includes a reservoir, an extraction tank, a distillation tank and a return line. The reservoir is for holding a solvent in liquid phase. The extraction tank is for receiving and flowing the solvent liquid through an oil containing material, for the solvent to extract oil from the material to yield a liquid mixture of the solvent and the oil. The distillation tank is for receiving the solvent/oil mixture and distilling off the solvent from the oil in the form of a solvent vapor. The return line is for returning the solvent vapor to the reservoir while leaving the oil in the distillation tank. An oil collection tank is connected to both distillation tanks for collecting the oil from both distillation tanks.

### BRIEF DESCRIPTION OF THE DRAWINGS

FIG. 1 is schematic diagram of first and second oil extraction systems interconnected with an oil collection tank;

FIG. 2 is schematic diagram of the first system;

FIGS. 3-10 are schematic diagrams of the first system in different modes of operation; and

FIG. 11 is a schematic diagram of parts of the first system interconnected with a heating/cooling system.

### DESCRIPTION

System Components

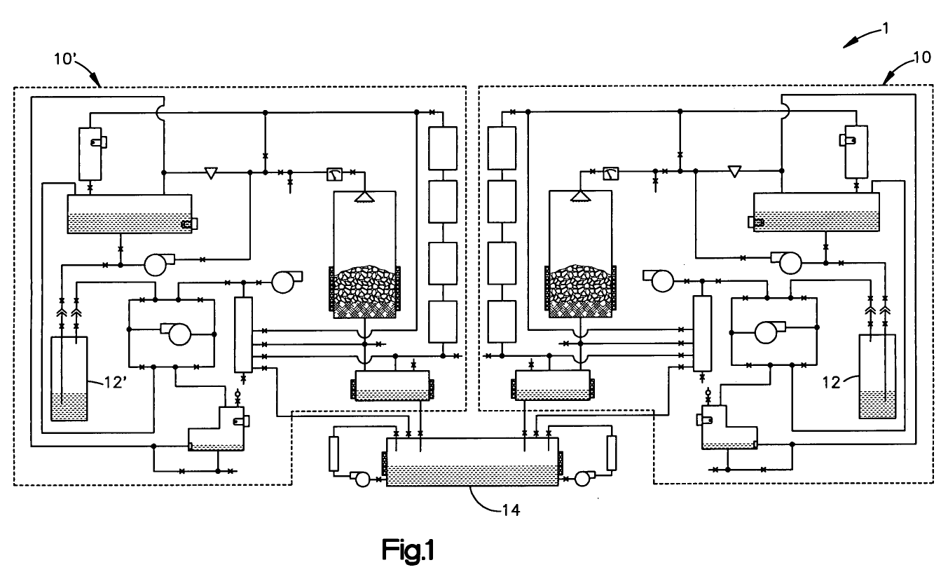

The apparatus 1 shown in FIG. 1 has parts that are examples of the elements recited in the claims.

The apparatus 1 includes first and second oil extraction systems 10 and 10′. Each system 10 and 10′ can extract oil from an oil bearing material. In this example, the oil bearing material is a plant material, specifically a mass of rose petals, and the oil is rose oil. The solvent is a liquid that can dissolve the oil, and can thus extract the oil from the oil-bearing material and entrain the oil. The solvent is more volatile than the oil and can therefore be distilled from the oil and recovered. The solvent is supplied to the systems 10 and 10′ by respective solvent supply tanks 12 and 12′. The oil extracted by both systems 10 and 10′ is deposited in a common oil collection tank 14. The systems 10 and 10′ are alike. They are described below with reference to the first system 10.

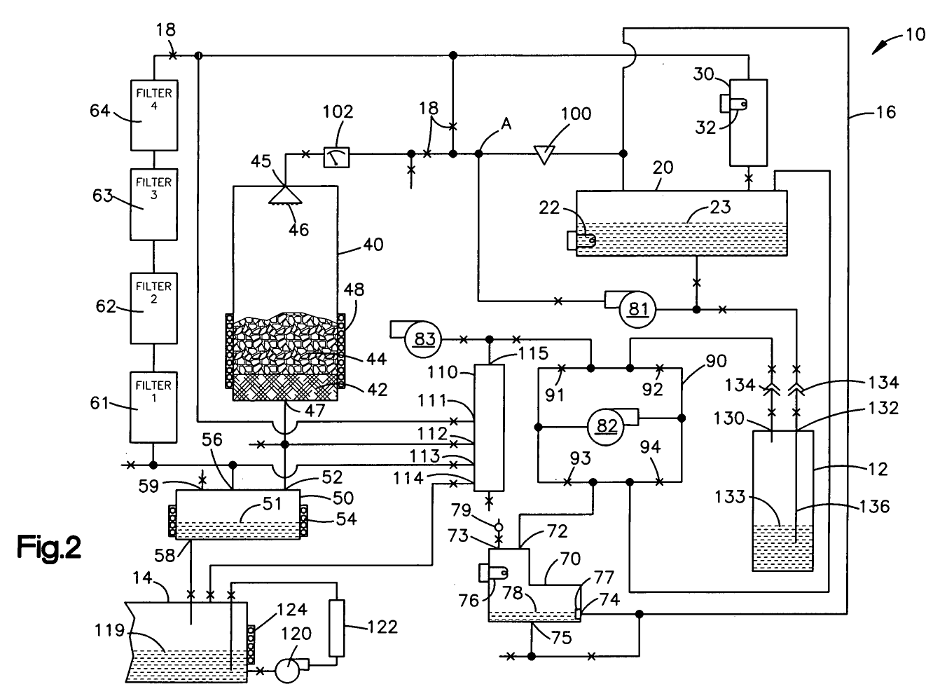

As shown in FIG. 2, the first system 10 has a variety of tanks that are interconnected with a fluid line 16 that includes a network of pipes. Flow of the solvent, oil and air through the line 16 is controlled by valves 18 that are located at various locations on the line 16 and schematically indicated by crosses. Some of the tanks have a coil for heating or cooling. In each case, the coil can be located within the tank and/or wrapped about the tank. The heating and cooling coils can be activated by flowing, respectively, hot and cold fluids through them. The heated and cooled tanks are preferably jacketed with an insulator.

A reservoir 20 is a tank that holds the solvent 23. The reservoir 20 has a cooling coil 22 for condensing solvent vapor into a liquid and for keeping it in liquid phase. A chiller 30 is located above the reservoir 20. The chiller 30 has a cooling coil 32 configured to condense solvent vapor into a liquid. The solvent liquid falls by gravity from the chiller coil 32 into the reservoir 20.

An extraction tank 40 holds a replaceable filter plug 42 configured to trap particles. The filter plug 42 is seated at the bottom of the tank 40 and supports the rose petals 44, which are placed above it in the tank 40. The tank 40 has an inlet 45 at its top and an outlet 47 at its bottom. The inlet 45 is connected to a sprayer 46 located within, and at the top of, the extraction tank 40. Solvent pumped into the tank 40 through the inlet 45 is sprayed by the sprayer 46 onto the rose petals 44. The solvent then flows through the petals 44, extracting oil from the petals 44 to yield a mixture of the solvent and the oil. The mixture continues through the filter plug 42 and the outlet 47. The extraction tank 40, like the other tanks of the system 10, can be opened for maintenance and for replacing its contents. The tank 40 has a heating coil 48 for warning the contents of the extraction tank 40 when purging the solvent from the system 10.

A distillation tank 50 receives the solvent/oil mixture 51 through its inlet 52 from the extraction tank 40. The mixture 51 is heated by a heating coil 54. This causes the solvent to evaporate off the solvent/oil mixture 51 and escape through an upper outlet 56 of the distillation tank 50, leaving the oil behind. The oil 51 can exit the tank 50 through a lower outlet 58 at the bottom of the tank 50. The distillation tank 50 has an air vent 59 that can be opened to enable air from the atmosphere to enter the tank 50.

The system 10 has a four filter tanks 61, 62, 63 and 64 connected in series. Each filter tank 61, 62, 63 and 64 is filled with a filtering material that removes a contaminant from the solvent. The first filter tank 61 is filled with a fibrous material that removes particles from the solvent. The second filter tank 62 is filled with a desiccant that removes water. The third filter tank 63 is filled with activated alumina that removes acid. The fourth filter tank 64 is filled with a filter material that removes particles that are entrained by the solvent from fillers of the second and third tanks 62 and 63. For an application where water or acid do not pose a problem, the filtering material of the second or third tank 62 and 63 can be replaced with a filtering material that removes a contaminant that does pose a problem. For example, the second or third tank 62 and 63 can be filled with activated carbon to remove odorous contaminants from the solvent.

A purge tank 70 is configured to purge from the system 10 contaminants that are more volatile than the solvent, such as air. The purge tank 70 has an inlet 72 for receiving a pressurized mixture of solvent and air. It also has an upper outlet 73, a lower outlet 74 and a bottom outlet 75. A cooling coil 76 located inside the purge tank 70 cools the air/solvent mixture. That, along with the elevated pressure, causes the solvent to condense and pool 78 at the bottom of the tank 70. The solvent 78 can exit the tank 70 through the lower and bottom outlets 74 and 75. To keep the air from escaping through the lower outlet 74, a float valve 77 keeps the lower outlet 74 closed until the liquid level 78 rises above the lower outlet 74. The air, which is not condensed, is vented to the atmosphere through the upper outlet 73. A relief valve 79 at the upper outlet 73 prevents the air from escaping unless it exceeds a threshold pressure.

The system has three pumps 81, 82 and 83. The first pump 81 is a solvent delivery pump, in this case a gear pump. It is configured to pump liquid solvent from the reservoir 20, through a junction labeled A on the line 16, to and through the extraction tank 40. The second pump 82, in this case a piston pump, is configured to pump gas. It is connected to the rest of the system 10 through a routing manifold 90 with four valves 91, 92, 93 and 94. The third pump 83 is vacuum pump, in this case a vane pump. It is configured evacuate the system 10 to purge it of air and solvent fumes.

From junction A, the solvent can flow onward to the extraction tank 40 or be diverted back to the reservoir 20. A metering valve 100 is used to adjust the flow rate of solvent being diverted back to the reservoir 20. This inversely affects the solvent flow rate to the extraction tank 40. A flow meter 102 measures and displays both the flow rate and the accumulated volume of solvent pumped to and through the extraction tank 40.

A manifold filter 110 has four inlets 111, 112, 113 and 114 connected to the system 10 at four locations. It has an outlet 115 connected to the second and third pumps 82 and 83 to prevent particles from fouling the second and third pumps 82 and 83.

The oil collection tank 14 collects the oil 119 discharged from the distillation tank 40. The oil in the collection tank 14 is circulated by a circulating pump 120 through a filter 122 that removes particles. The collection tank 14 has a heating coil 124 to warm the oil.

The solvent supply tank 12 has two ports 130 and 132 through which solvent 133 can enter and leave the tank 14. They are removably connected to two fittings 134 on the system 10. One port 130 opens to a location in and at the top of the tank 12. The other port 132 opens, through a dip tube 136, to a location in and at the bottom of the tank 12.

System Operation

The procedure for using the system 10 is explained below. In the relevant drawings, flow paths of solvent and oil through the line 16 are represented by arrows and by portions of the line 16 being drawn with heavier weight lines. It should be understood by the reader which valves 18 need to be opened and which need to be closed to achieve those flow paths.

The first step is to charge the extraction tank 40. The user opens the extraction tank 40, seats the filter plug 42 inside, places a load of rose petals 44 over the filter plug 42, and closes the extraction tank 40. The user can similarly replace the contents of the filter tanks 61, 62, 63, 64 and 110.

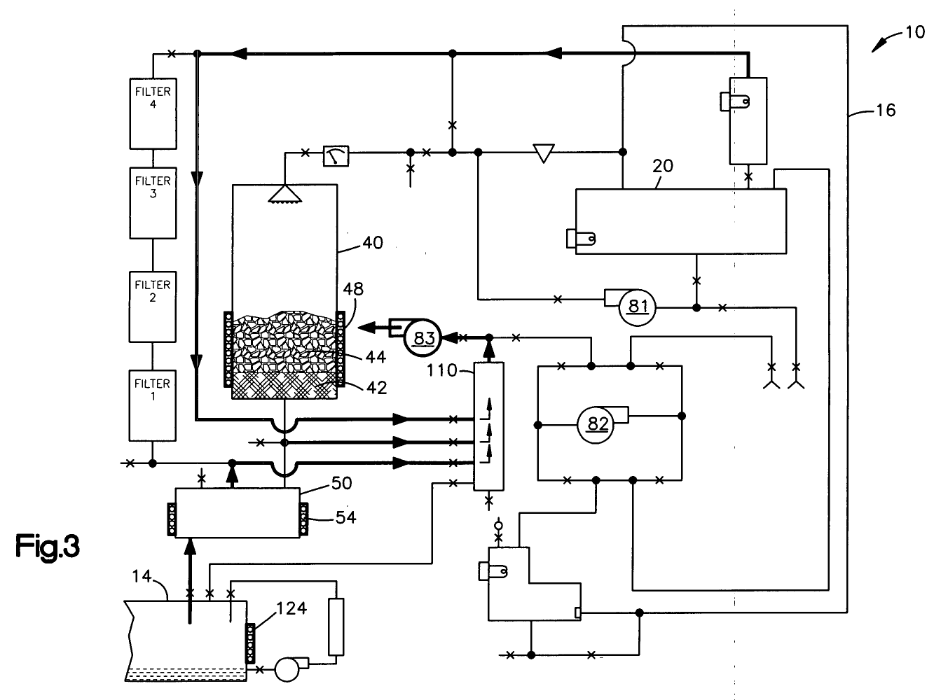

In a second step, illustrated in FIG. 3, the system 10 is evacuated. In this step, the extraction, distillation and collection tanks 40, 50 and 14 are heated by activating their heating coils 48, 54 and 124. This is indicated by the heating coils 48, 54 and 124 being drawn with heavier weight lines. The vacuum pump 83 is turned on, as indicated by its being drawn with heavier weight lines. As indicated by the arrows in FIG. 3, air flows from various locations on the line 16, through the manifold filter 110 and the vacuum pump 83, and out to the atmosphere.

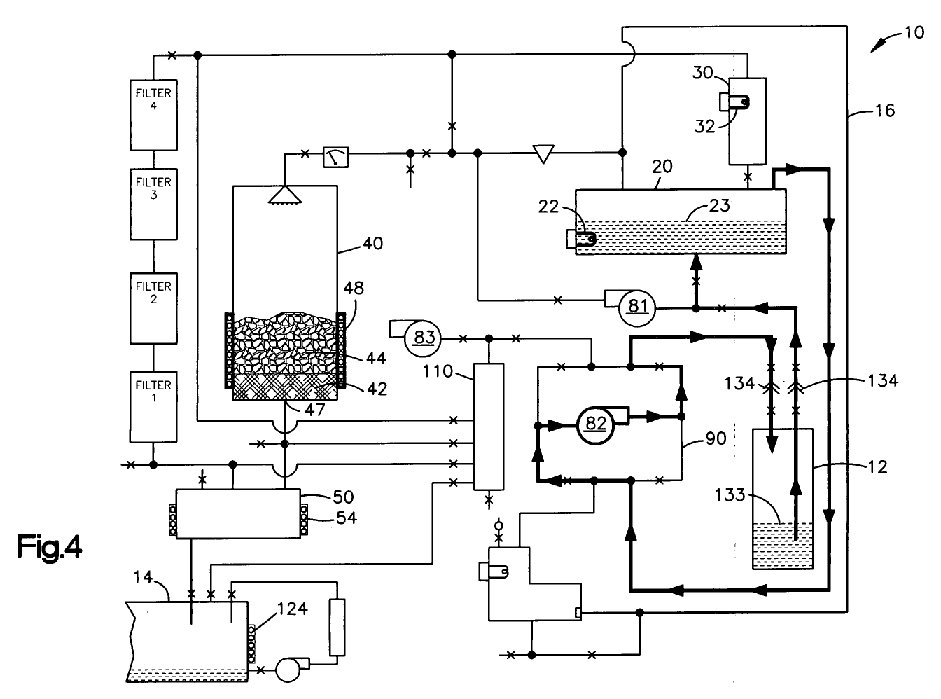

In a third step, illustrated in FIG. 4, the reservoir 20 is filled with solvent 23 from the supply tank 12. To implement this, the supply tank 12 is connected to the system 10 through the fittings 134. The reservoir and chiller 20 and 30 are cooled by activating their cooling coils 22 and 32. The extraction tank 40 is heated by activating its heating coil 48. The second pump 82 is turned on. At first, solvent vapor from the tank 12 fills the reservoir 20. The second pump 82 forces the vapor from the reservoir 20 back into the cylinder 12. That, in turn, forces solvent 133 out of the cylinder 12, through the line 16, into the reservoir 20. The flow is enhanced by the temperature differential between the supply tank 12 and the reservoir 20, which thermally drives the solvent 133 from the tank 12 into the reservoir 20.

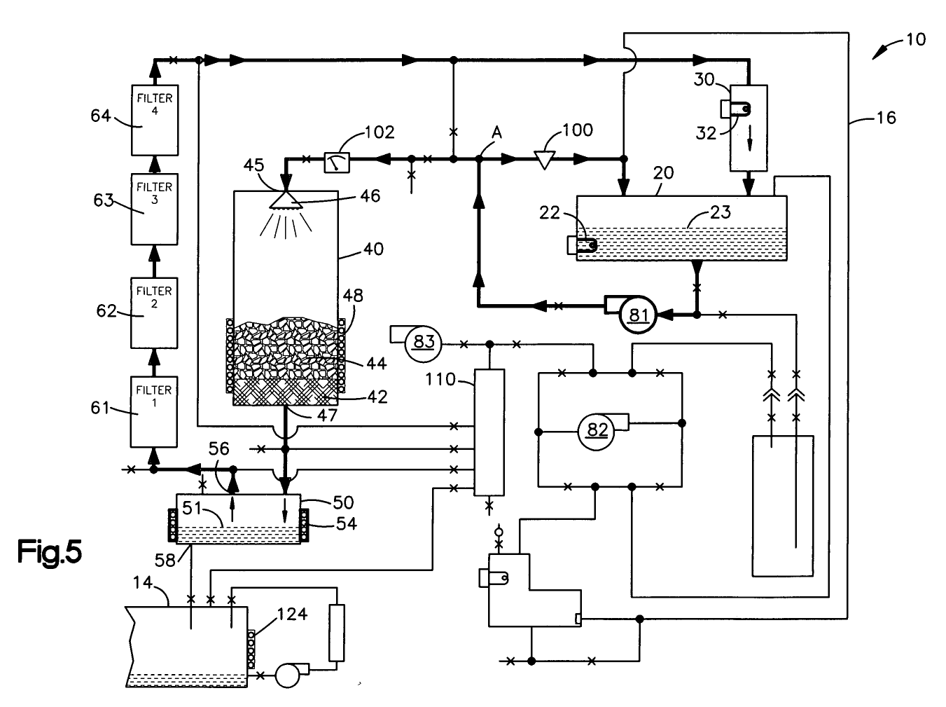

A fourth step, illustrated in FIG. 5, is an extraction/recovery step. In this step, solvent 23 is pumped from the reservoir 20 through the rose petals 44 to extract rose oil. The solvent is then separated from the oil, and returned to the reservoir 20. To achieve this, the reservoir 20 and the chiller 30 are cooled by their cooling coils 22 and 32. The distillation tank 50 is heated by its heating coil 54. The first pump 81 is turned on.

The pump 81 forces solvent 23 from the reservoir 20 to junction A. From there, a portion of the solvent is diverted back to the reservoir 20 while the remainder continues on to the inlet 45 of the extraction tank 40. The sprayer 46 sprays the solvent onto the petals 44. While flowing through the petals 44, the solvent extracts and entrains rose oil from the petals 44. Under the force of gravity, the mixture of solvent and oil flows through the extraction tank outlet 47 and is deposited in the distillation tank 50.

Within the distillation tank 50, the solvent/oil mixture is pooled as a liquid 51. The distillation tank 50 is heated by its heating coil 54 to a temperature that is high enough to evaporate the solvent, but low enough to avoid decomposing or evaporating the oil. The solvent is evaporated off the mixture and flows out the upper outlet 56 of the distillation tank 50 in the form of a solvent vapor, leaving the oil in the distillation tank 50. The solvent continues through the series of filter tanks 61, 62, 63 and 64 to remove any particles, water and acid. From the fourth filter tank 64, the solvent flows through the chiller 30 back to the reservoir 20.

The flow of the solvent from the distillation tank 50 to the reservoir 20 is entirely thermally driven by a temperature differential. The temperature differential is defined by a temperature within the reservoir 20 and the chiller 30 being low enough to condense the solvent vapor, and a temperature within the distillation tank 50 being too high to condense the solvent. Continuous condensing of the solvent vapor within the reservoir 20 and the chiller 30 produces a local partial vacuum that continuously draws solvent vapor from the distillation tank 50. Any solvent vapor condensed in the chiller 30 drops by gravity into the reservoir 20.

The aforementioned sub-steps of pumping solvent to the extraction tank 40, extracting the oil, distilling the solvent from the oil and thermally driving the solvent back to the reservoir 20 are cyclically repeated with the same solvent that was returned to the reservoir 20 in a previous sub-step. Moreover, these sub-steps are performed simultaneously and continuously, with the solvent cyclically flowing continuously through the reservoir 20, the extraction tank 40, the distillation tank 50 and the filter tanks 61, 62, 63 and 64. This continues typically until all of the oil is removed from the petals 44.

During the extraction/recovery step, the solvent is not compressed. Any mechanical pumping of the solvent is done only where, on the line 16, the solvent is in the incompressible liquid phase, but not where the solvent is in the compressible vapor phase. This reduces the chance of the solvent being heated by compression to a temperature where it, or any oil entrained in it, might degrade.

Furthermore, during the extraction/recovery step, the temperature of the solvent never exceeds 100 degrees F. In fact, the reservoir temperature at which the solvent is maintained in the reservoir 20 and the pumping temperature at which the solvent is pumped to the extraction tank 40 are preferably below −10 degrees F. and more preferably below −30 degrees F. This is so that the spray temperature, at which the solvent exits the sprayer 46, is below −10 degrees F. and more preferably below −30 degrees F. The petals 44 are themselves cooled down to the spray temperature by the cold solvent soon after the spraying begins. The reservoir temperature, the pumping temperature and the spray temperature are preferably at a cell breaking temperature, defined as a temperature at which cells of the petals 44 break open from the cold. This facilitates the extraction of the oil from the petals 44.

The solvent is “recovered” in that it is separated from the oil and returned to the reservoir 20. Furthermore, the solvent is “reclaimed” in that it reenters the reservoir 20 in a state meeting virgin standards under ARI (American Refrigerant Institute) specifications. In fact, the purity of the solvent at the end of the extraction/recovery step meets or exceeds the purity of the solvent at the start of the extraction/recovery step.

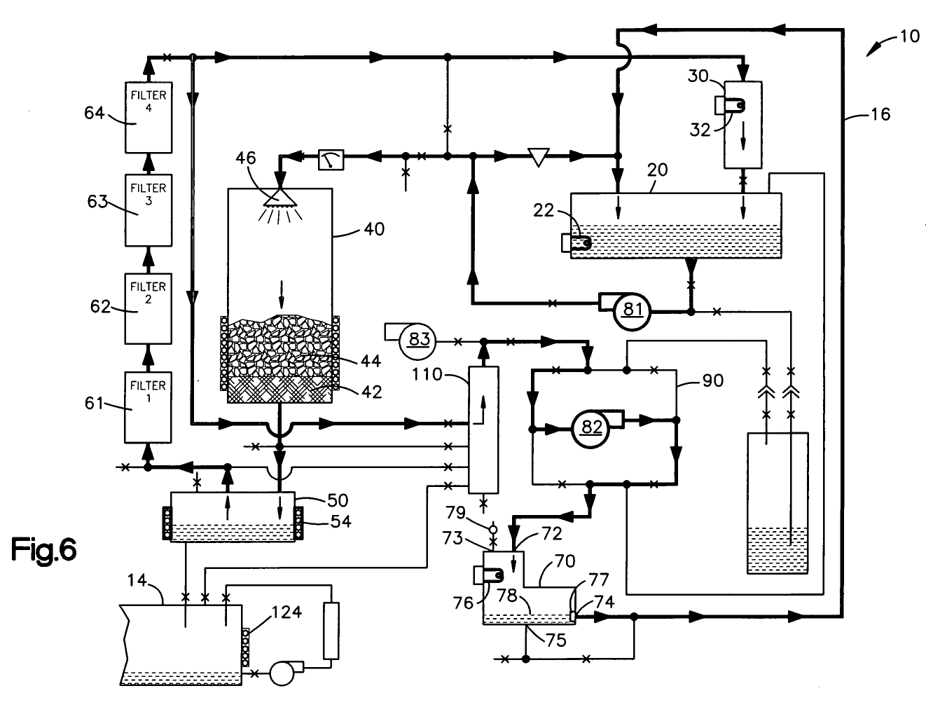

During the extraction/recovery step, the system 10 is closed to the atmosphere in that its cavity and contents are sealed off from the atmosphere. However, a contaminant more volatile than the solvent, such as air, might unintentionally enter the system 10. The air can be purged from the system 10 as illustrated in FIG. 6. This can be done without interrupting the extraction and recovery and without opening the system 10 to the atmosphere.

To implement this, the distillation tank 50 remains heated. The reservoir 20 and the chiller 30 remain cooled. The purge tank 70 is cooled by activating its cooling coil 76. The first pump 81 remains on, and the second pump 82 is turned on. The solvent vapor and air is drawn from the fourth filter tank 64, through the filter manifold 110, through the second pump 82 and into the purge tank 70. Within the purge unit 70, the solvent vapor condenses into a pool of solvent liquid 78 at the bottom of the tank 70. The solvent 78 exits the purge tank 70 through the float valve 77 and the lower outlet 74. The air is vented to the atmosphere through the upper outlet 73 and the relief valve 79.

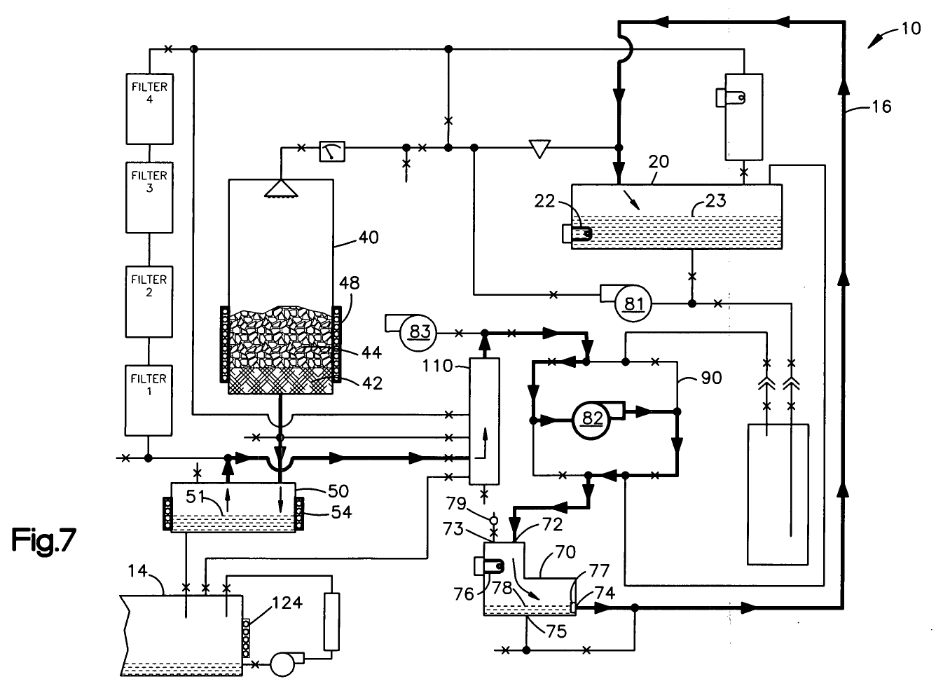

In a fifth step, illustrated in FIG. 7, all liquid solvent in the system 10, including solvent wetting the petals 44, is returned to the reservoir 20. In this step, the extraction and distillation tanks 40 and 50 are heated by their heating coils 48 and 54. The purge tank 70 is cooled by its cooling coil 76. The second pump 82 is turned on. This draws solvent from the extraction tank 40, through distillation tank 50, the manifold filter 110 and the second pump 82, into the purge tank 70. In the purge tank 70, any air is vented through the upper outlet 73 to the atmosphere. Concurrently, the solvent is condensed, pooled 78 at the bottom of the purge tank 70, and discharged through the float valve 77 and lower outlet 74. From there, the solvent returns to the reservoir 20.

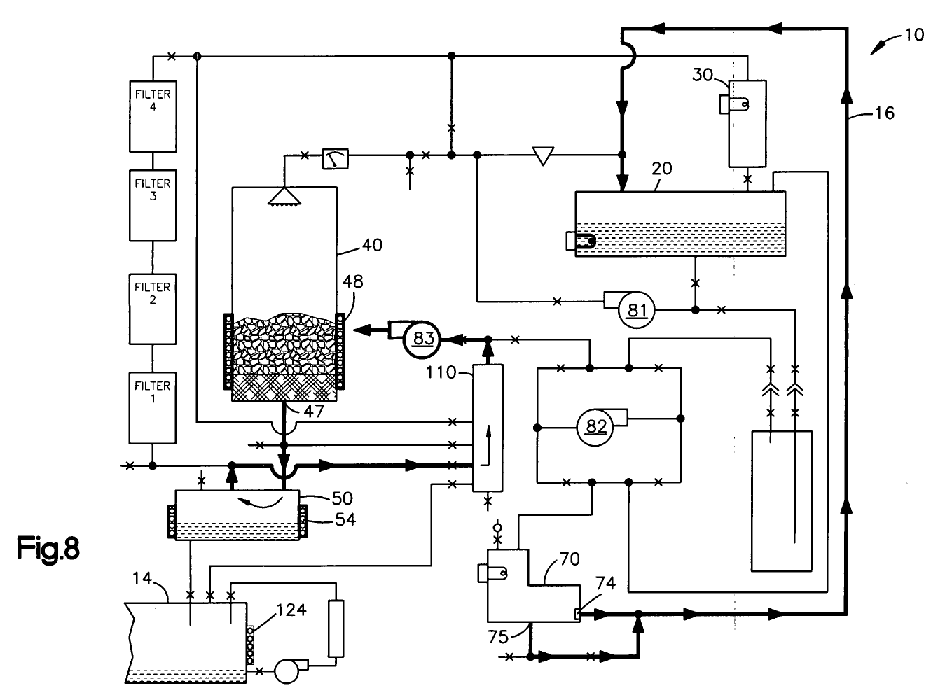

In a sixth step, illustrated in FIG. 8, solvent vapor is purged from the line 16. To achieve this, the extraction and distillation tanks 40 and 50 are heated by their heating coils 48 and 54. The reservoir 20 is cooled by its cooling coil 22. The vacuum pump 83 is turned on. This causes solvent vapor in the extraction tank 40 to flow through the distillation tank 50, the manifold filter 110 and the vacuum pump 83, to the atmosphere. Concurrently, solvent vapor in the purge tank 70 flows out the lower and bottom outlets 74 and 75 and into the reservoir 20 where it condenses. This flow is thermally driven by a temperature differential defined by the reservoir 20 being colder than the purge tank 70.

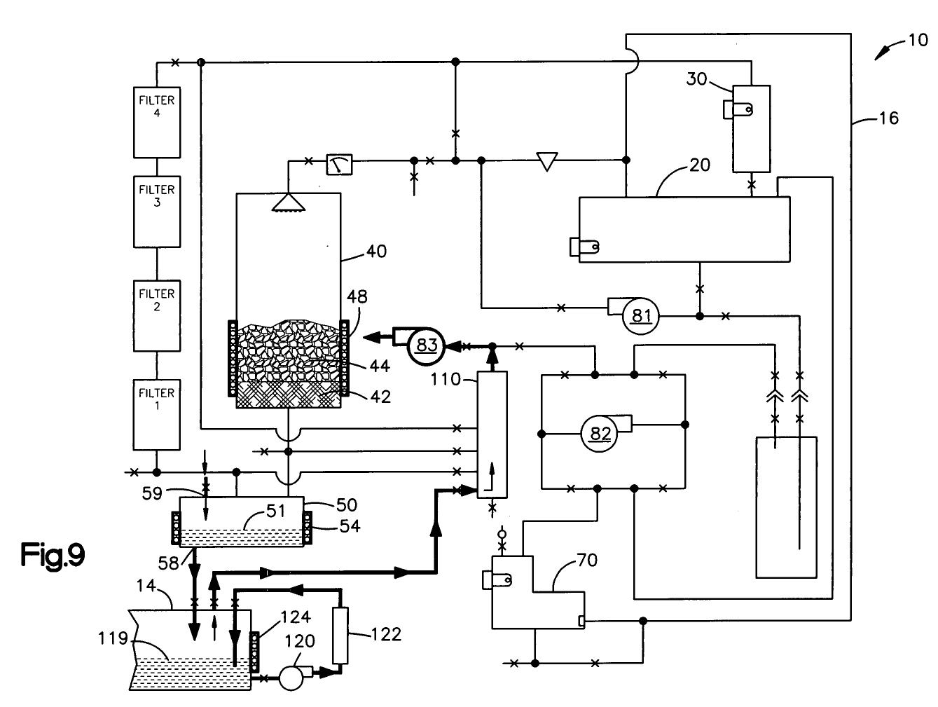

In a seventh step illustrated in FIG. 9, oil 51 in the distillation tank 50 is drained to the collection tank 14. To achieve this, the extraction, distillation and collection tanks 40, 50 and 14 are heated by their heating coils 48, 54 and 124. The vacuum pump 83 is turned on, and the distillation tank air vent 59 is opened. Air from the atmosphere enters the distillation tank 50 through the vent 59. Oil 51 in the distillation tank 50 is drawn into the collection tank 14. Air and solvent vapor in the collection tank 14 is drawn through the manifold filter 110 and the vacuum pump 83 to the atmosphere. The oil 119 in the collection tank 14 is circulated by the circulating pump 120 through the oil filter 122 to remove any particles.

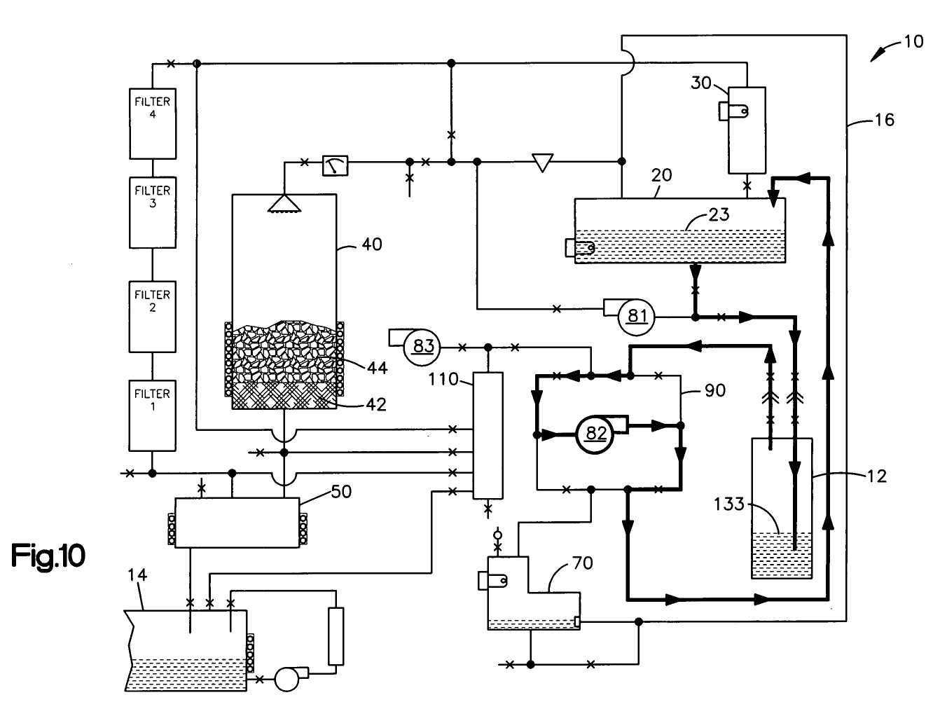

In an eighth step illustrated in FIG. 10, the liquid solvent 23 in the reservoir 20 is returned to the supply tank 12. To achieve this, the second pump 82 is turned on. Solvent vapor flows from the supply tank 12, through the second pump 82, into the reservoir 20. This forces the solvent liquid 23 out of the reservoir 20 and into the supply tank 12.

After the solvent is removed in this eighth step, the petals 44 can be removed from the extraction tank 40 and discarded. Alternative, the petals 44 can remain in the extraction tank 40 so that a second solvent, with a different molecular structure than the first solvent, can be used to extract a different type of oil from the same petals 44. To achieve this, steps three through eight are repeated, this time with the second solvent 23 from a second supply tank 12. This sequence can be repeated for any number of solvents. The solvents can be the same, or can differ from each other in molecular structure or only in purity. The operations of removing the first solvent in step eight, replacing it with a second solvent in step three, and extracting the oil in step four, can all be done while the system 10 remains closed to the atmosphere.

After the petals 44 are removed from the extraction tank 40 and discarded, a second oil bearing material can be placed in the extraction tank 40 in accordance with the first step. The second material can be different than the first, such as coffee for the extraction of coffee concentrate. The same solvent used previously for extracting rose oil can now be used for extracting coffee concentrate. The solvent will not contaminate the coffee concentrate with the taste or smell of the rose oil that was previously extracted. That is because the system 10 “reclaims” the solvent, as mentioned above. In fact, the solvent has the same or higher purity at the end of the extraction/recovery step than at the start of the extraction/recovery step. The solvent thus carries no smell or taste from the previous extraction.

As shown in FIG. 1, both the first and second oil extraction systems 10 and 10′ are connected to the same oil collection tank 14. The eight-step procedure described above can be implemented with both systems 10 and 10′. The systems 10 and 10′ can be operating simultaneously. They can also be operated alternatingly, with the first system 10 performing the extraction/recovery step while the second system 10′ undergoes other steps, and vice versa.

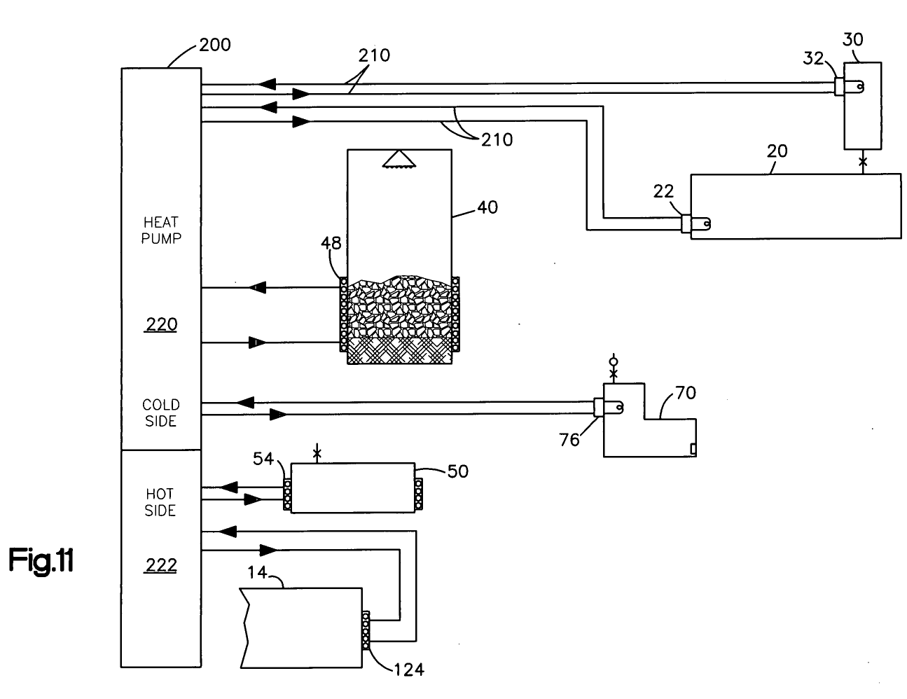

FIG. 11 is a schematic diagram of a heating/cooling system 200 connected to various tanks 14, 20, 30, 40, 50 and 70 of the oil extraction system 10 through fluid lines 210. As indicated by arrows on the fluid lines 210, the heating/cooling system 200 circulates cool fluid through the cooling coils 22, 32 and 76 as needed and warm fluid through the heating coils 48, 54 and 124 as needed. The heating/cooling system 200 includes a heat pump which continuously pumps heat from a cold side 220 to a hot side 222, with the cooling fluid provided from the cold side 220 and the heating fluid provided from the hot side 222.

During the extraction/recovery step, the cold side 220 cools the reservoir and chiller 20 and 30, and the hot side 222 heats the distillation and collection tanks 50 and 14. The rate, in cal/hr, at which heat is added to the collection tank 14 is initially small and quickly drops off to essentially zero, since no evaporation or condensation occurs in the oil collection tank 14. The cold side 220 withdraws heat from the system 10 at the reservoir 20 at a first rate. This includes heat removed from the chiller 20 and the reservoir 30. Concurrently, the hot side 222 adds the heat back to the system 10 at the distillation tank 50 at a second rate. Preferably, the rates differ from each other by less than about 2% and more preferably by less than about 1%.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. An oil extraction method comprising:
pumping a solvent in liquid phase from a solvent reservoir through an oil containing material for the solvent to extract oil from the material to yield a mixture of the solvent and the oil;
depositing the solvent/oil mixture in a distillation tank;
distilling off the solvent from the mixture in the form of a solvent vapor; and
thermally driving the solvent vapor from the tank back to the reservoir by applying a temperature differential, while leaving the oil in the distillation tank.

2. The method of claim 1 further comprising cyclically repeating the pumping, depositing, distilling and driving steps with the same solvent that is returned to the reservoir in the previous driving step.

3. The method of claim 1 wherein the pumping, depositing, distilling and driving steps are performed continuously and simultaneously, with the solvent flowing cyclically through the reservoir and the distillation tank.

4. The method of claim 1 wherein the reservoir and the distillation tank are parts of an oil extraction system that is closed to the atmosphere during the pumping, depositing, distilling and driving steps, and the method further comprises replacing the solvent in the reservoir with a second solvent while the system remains closed to the atmosphere.

5. The method of claim 4 wherein the second solvent is of different molecular structure than the first solvent.

6. The method of claim 1 wherein the solvent temperature is below −30 degrees F. as it is being pumped and extracting the oil from the oil containing material.

7. The method of claim 1 wherein the solvent temperature is at a cell breaking temperature as it is being pumped and extracting the oil from the oil containing material.

8. The method of claim 1 wherein the driving step includes thermally driving the solvent through a filter to the reservoir, and the distilling and driving steps reclaim the solvent to virgin standards.

9. An oil extraction system comprising:
a reservoir for holding a solvent liquid;
an extraction tank for flowing the solvent liquid through an oil containing material for the solvent to extract oil from the material to yield a mixture of the solvent and oil;
a distillation tank for distilling off the solvent from the mixture in the form of a solvent vapor;
a pump configured to pump the solvent liquid from the reservoir to the extraction tank; and
a thermal drive apparatus configured to thermally drive the solvent vapor from the distillation tank back to the reservoir.

10. The system of claim 9 wherein the thermal drive apparatus includes a heating device for heating the mixture in the distillation tank and a cooling device for cooling the solvent in the reservoir, to produce a temperature differential between the reservoir and the distillation tank.

11. The system of claim 9 further including a chiller, connected between the distillation tank and the reservoir, that is located above the reservoir and that cools the solvent vapor from the distillation tank for the solvent vapor to condense and fall into the reservoir.

12. The system of claim 9 configured for the solvent to flow cyclically through the reservoir, the extraction tank and the distillation tank.

13. The system of claim 9 configured for the solvent to flow simultaneously through the reservoir, the extraction tank and the distillation tank.

14. An oil extraction apparatus comprising:
first and second oil extraction systems, each system including a reservoir for holding a solvent in liquid phase, an extraction tank for receiving and flowing the solvent liquid through an oil containing material for the solvent to extract oil from the material to yield a liquid mixture of the solvent and the oil, a distillation tank for receiving the solvent/oil mixture and distilling off the solvent from the oil in the form of a solvent vapor, and a return line for returning the solvent vapor to the reservoir while leaving the oil in the distillation tank; and
an oil collection tank connected to both distillation tanks for collecting the oil from both distillation tanks.

15. The oil extraction apparatus of claim 14 wherein each system further comprises a pump for pumping the solvent from the reservoir to the extraction tank and a thermal drive apparatus configured to thermally drive the solvent from the distillation tank to the reservoir.

16. The oil extraction apparatus of claim 14 wherein each system is configured to be closed to the atmosphere during the flowing, the extracting and the distilling, and further configured to enable replacing the solvent with a second solvent while the system remains closed to the atmosphere.

17. An oil extraction system comprising:
a reservoir for holding a solvent liquid;
an extraction tank for flowing the solvent liquid through an oil containing material for the solvent to extract oil from the material to yield a mixture of the solvent and oil;
a distillation tank for distilling off the solvent from the mixture in the form of a solvent vapor; and
a return line for returning the solvent vapor back to the reservoir;
the system being configured to be closed to the atmosphere during the flowing, the extracting and the distilling, and further configured to enable replacing the solvent in the system with a second solvent while the system remains closed to the atmosphere.

18. An oil extraction system comprising:
a reservoir for holding a solvent liquid;
an extraction tank for flowing the solvent liquid through an oil containing material for the solvent to extract oil from the material to yield a mixture of the solvent and oil;
a distillation tank for distilling off the solvent from the mixture in the form of a solvent vapor; and
a thermal driving apparatus configured to thermally drive the solvent vapor from the distillation tank to the reservoir, the apparatus comprising a heat pump having a cold side configured to withdraw heat from the system at the reservoir and having a hot side configured to add the heat back to the system at the distillation tank.

19. An oil extraction system comprising:
a reservoir for holding a solvent liquid;
an extraction tank for flowing the solvent liquid through an oil containing material for the solvent to extract oil from the material to yield a mixture of the solvent and oil;
a distillation tank for distilling off the solvent from the mixture in the form of a solvent vapor; and
a line, closed to the atmosphere, for conducting the liquid solvent from the reservoir to the extraction tank, and conducting the mixture from the extraction tank to the distillation tank, and conducting the solvent vapor from the distillation tank to the reservoir; and
a purge tank for purging, from the line, a contaminant that is more volatile than the solvent without interrupting the flowing, the distilling and the conducting, the purge tank having an inlet for receiving the solvent and the contaminant from the line, a cooling device for condensing the solvent but not the contaminant, a lower outlet for discharging the condensed solvent back into line, and an upper outlet for discharging the contaminant into the atmosphere.

20. An oil extraction method comprising:
flowing a liquid solvent from a solvent reservoir through an oil containing material for the solvent to extract oil from the material to yield a mixture of the solvent and the oil;
depositing the mixture in a distillation tank;
distilling off the solvent from the mixture in the tank in the form of a solvent vapor; and
thermally driving the solvent vapor from the tank back to the reservoir by applying a temperature differential, the temperature differential being achieved by withdrawing heat at the reservoir at a first rate and adding the heat to the distillation tank at a second rate, the rates differing from each other by less than about 2%;
the flowing, depositing, distilling and thermally driving steps being performed continuously and simultaneously with the solvent flowing cyclically through the reservoir and the distillation tank.

21. The method of claim 20 wherein the withdrawing and the adding of heat are respectively provided by hot and cold sides of a single heat pump.

22. An oil extraction method comprising:
flowing a liquid solvent from a solvent reservoir through an oil containing material for the solvent to extract oil from the material to yield a mixture of the solvent and the oil;
depositing the mixture in a distillation tank;
distilling off the solvent from the mixture in the tank in the form of a solvent vapor; and
returning the solvent vapor from the tank back to the reservoir in a state meeting virgin standards.
